(19) United States
(12) Patent Application Publication
(10) Pub. No.: US 2013/0042832 A1
(43) Pub. Date: Feb. 21, 2013

(54) ENGINE RESTART APPARATUS

(71) Applicants: Jaehyun Park, Seoul (KR); Jaewoong Kim, Hwaseong-si (KR); Joonhyung Park, Hwaseong-si (KR); Sanghun Kim, Hwaseong-si (KR)

(72) Inventors: Jaehyun Park, Seoul (KR); Jaewoong Kim, Hwaseong-si (KR); Joonhyung Park, Hwaseong-si (KR); Sanghun Kim, Hwaseong-si (KR)

(73) Assignee: HYUNDAI MOTOR COMPANY, Seoul (KR)

(21) Appl. No.: 13/304,000

(22) Filed: Nov. 23, 2011

(30) Foreign Application Priority Data
Aug. 19, 2011 (KR) 10-2011-0082881

(51) Int. Cl. F02N 5/04; F02N 11/00

(52) U.S. Cl. 123/179.22

(57) ABSTRACT

An engine restart apparatus for improving fuel efficiency and reducing torque of an engine may comprise a double-mass type flywheel unit including a main flywheel rotating with an engine connected to a power train and having a ring gear to receive a power from a starter motor and a sub-flywheel rotatably fitted on a crankshaft of the engine and selectively connected to the main flywheel, a power control circuit forming an electric circuit connecting a battery with the sub-flywheel, and a controller combining the sub-flywheel with the main flywheel by connecting an electric current supplied to the sub-flywheel through a power control circuit or separating the sub-flywheel from the main flywheel by cutting the electric current supplied to the sub-flywheel, in accordance with the engine load condition, the engine start condition, and the vehicle mode condition.

### CROSS-REFERENCE TO RELATED APPLICATIONS

The present application claims priority of Korean Patent Application Number 10-2011-0082881 filed Aug. 19, 2011, the entire contents of which application are incorporated herein for all purposes by this reference.

### BACKGROUND OF INVENTION

1. Field of Invention

The present invention relates to a vehicle provided with Idle Stop and Go (ISG) function, and more particularly, to an engine restart apparatus that can prevent deterioration of durability of a starter motor while greatly improving fuel efficiency by decreasing moment of inertia of the flywheel in Idle Stop to reduce unnecessary waste of kinetic energy.

2. Description of Related Art

In general, an Idle Stop and Go (ISG) function is for controlling stopping of idling of an engine and makes it possible to achieve economical effect of fuel by repeating starting and stopping of an engine in accordance with road conditions.

For this function, an ISG logic gives an order to stop the engine in idling in response to input information, such as the vehicle speed, engine speed, and the temperature of cooling water. A vehicle provided with the ISG can achieve fuel saving of 5 to 15% in the actual fuel efficiency mode.

In general, an ISG vehicle also converts from Idle Stop to Idle Go, in addition to initial starting of the engine by using a starter motor transmitting power to the flywheel.

FIG. 4 shows an engine start circuit of an ISG vehicle equipped with a starter motor, as described above.

As shown in the figure, the engine start circuit includes a controller 100 receiving engine start-relating signals, a power control circuit 200 switching battery current under the control of controller 100, and a starter motor 300 operated by current supplied from power control circuit 200 and starting the engine by rotating the flywheel.

As the engine start circuit is configured, as described above, when the engine is started or restart is required by conversion into Idle Go from Idle Stop, starter motor 300 is operated by the battery current and engages the pinion gear with the ring gear of the flywheel, thereby starting the engine.

In general, the flywheel is implemented by one integral mass having moment of inertia according to the specification of the engine.

Therefore, starter motor 300 needs torque against the moment of inertia of the flywheel when the engine is started, and particularly, durability is reduced by a mechanical collision between gears that are engaged to start the engine.

Accordingly, the durability of starter motor 300 should be designed not to be forced even under a large number of starting of the engine.

However, as the engine of the ISG vehicle is started and stopped a great number of times in comparison to general vehicles, the number of times of operating the flywheel of starter motor 300 increases, such that the design of durability of starter motor 300 is necessarily limited.

This problem becomes severe, as the flywheel implemented by one integral mass having the maximum moment of inertia for the specification of the engine is operated by starter motor 300 every time the engine is started.

As described above, the durability of starter motor 300 requires a specific starter motor with a high-level specification appropriate to the ISG vehicle, which is a factor increasing the cost of the ISG vehicle.

However, the high-level specification of starter motor 300 further increases battery load when the engine is started, where a large amount of electric energy is required, and the level of specification of the battery should be increased, such that it is necessary to increase the level of specification of the alternator, which necessarily increases the weight with reduction of fuel efficiency of the ISG vehicle.

Korean Patent Application Laid-Open No. 10-2010-0062639 (Oct/ 6, 2010) discloses an engine start system of a vehicle in FIGS. 3 to 6.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention are directed to provide an engine start apparatus that can improve fuel efficiency and reduce torque of an engine by keeping the total of moment of inertia of a flywheel unit high in starting of engine or a low-velocity section and keeping it low by separating a mass having high moment of inertia in a high-velocity section. Exemplary engine start apparatuses according to the present invention can prevent reduction of durability of a starter motor by reducing start torque of the starter motor, using the rotational kinetic energy accumulated in the mass having high moment of inertia in conversion into Idle Go from Idle Stop by ISG. This is achieved by applying a flywheel unit having the total moment of inertia comprised of a mass having high moment of inertia and a mass having low moment of inertia.

Various aspects of the present invention provide for an engine start apparatus including a main flywheel affixed to a crankshaft of an engine selectively connected to a power train, the main flywheel having a ring gear on an outer circumferential surface to receive a torque from a starter motor, and implemented with a mass having a moment of inertia of the main flywheel, and a sub-flywheel rotatably fitted on the crankshaft of the engine and selectively connected to the main flywheel, the sub-flywheel implemented with a mass having a moment of inertia of the sub-flywheel, increasing a moment of inertia of a flywheel unit by being engaged and rotated with the main flywheel.

The main flywheel may be a low moment of inertia type for a high velocity, while the sub-flywheel may be a high moment of inertia type for a low velocity.

The sub-flywheel may be moved to the main flywheel by a magnetic force generated by applying electric current, and combined with the main flywheel.

The main flywheel may be fitted on the crankshaft of the engine through a shaft hole at a center of the main flywheel and simultaneously rotates with the engine, and the sub-flywheel may include a flywheel mass rotatably fitted on the crankshaft of the engine through a ball bearing, and an electromagnetic clutch providing a magnetic pulling force generated by the applied electric current, wherein the ball bearing is fitted in a shaft hole at a center of the flywheel mass.

The electromagnetic clutch may be disposed inside the flywheel mass, substantially coaxially with the shaft hole, and forms an electric circuit to receive a current from the battery.

Driving conditions of the engine for combining and separating the main flywheel and the sub-flywheel may include an engine load condition, an engine start condition, and a vehicle mode condition. Low-velocity section and high-velocity section conditions are applied to the engine load condition, conversion into Idle Go from Idle Stop by ISG and initial start of the engine are applied to the engine start condition, and a fuel cut condition or a regenerative braking condition is applied to the vehicle mode condition.

The total moment of inertia of the sub-flywheel and the main flywheel may act as a load on the crankshaft of the engine when the engine load condition is the low-velocity section condition, and/or the engine start condition is the initial start of the engine or the conversion into Idle Go from Idle Stop by ISG, whereas only the moment of inertia of the main flywheel may act as the load on the crankshaft of the engine when the engine load condition is the high-velocity section condition, and/or the vehicle mode condition is the fuel cut condition or the regenerative braking condition.

The number of revolution of engine for a specific condition Ne1 at which the moment of inertia of the flywheel unit is converted into a relatively low value from a high value is defined in determination for the low-velocity section and the high-velocity section. The low-velocity section condition may be defined as Ne<Ne1−α and the high-velocity section condition may be defined as Ne≧Ne1+β, wherein Ne is a number of revolution of the engine, Ne1 is a number of revolution of the engine for a specific condition, and α and β are predetermined factors according to a traveling condition of a vehicle and a state of an engine.

Various aspects of the present invention provide for an engine restart apparatus including a double-mass type flywheel unit including a main flywheel rotating with an engine connected to a power train and having a ring gear to receive a power from a starter motor and a sub-flywheel rotatably fitted on a crankshaft of the engine and selectively connected to the main flywheel, a power control circuit forming an electric circuit connecting a battery with the sub-flywheel, and a controller for controlling the flywheel unit based on an engine load condition, an engine start condition and a vehicle mode condition. A low-velocity section condition and a high-velocity section condition are applied to the engine load condition, an initial start of the engine and a conversion into Idle Go from Idle Stop by ISG are applied to the engine start condition, and where a fuel cut condition or a regenerative braking condition is applied to the vehicle mode condition. The controller combines the sub-flywheel with the main flywheel by connecting an electric current supplied to the sub-flywheel through a power control circuit or separates the sub-flywheel from the main flywheel by cutting the electric current supplied to the sub-flywheel, in accordance with the engine load condition, the engine start condition, and the vehicle mode condition.

The main flywheel may have the ring gear on an outer circumferential surface and is fitted on the crankshaft of the engine to simultaneously rotate through a shaft hole at a center of the main flywheel, and the sub-flywheel may include a flywheel mass rotatably fitted on the crankshaft of the engine through a ball bearing fitted in a shaft hole at a center of the flywheel mass, and an electromagnetic clutch providing a magnetic pulling force generated by the applied electric current.

Similarly, in other aspects of the present invention, the total of moment of inertia of the sub-flywheel and the main flywheel acts as load on the crankshaft of the engine in the low-velocity section in the engine load condition, the initial start of the engine that is the engine start condition, and the conversion into Idle Go from Idle Stop by ISG, while only the moment of inertia of the main flywheel acts as load on the crankshaft of the engine in the high-velocity section in the engine load condition, and the fuel cut condition or the regenerative braking condition in the vehicle mode condition.

The low-velocity section condition may be defined as Ne<Ne1−α and the high-velocity section condition may be defined as Ne≧Ne1+β, wherein Ne is a number of revolution of the engine, Ne1 is a number of revolution of the engine for a specific condition, and α and β are predetermined factors according to a traveling condition of a vehicle and a state of an engine.

According to various aspects of the present invention, it is possible to improve fuel efficiency and reduce torque of the engine in a high-velocity section by using the flywheel unit with a mass having high moment of inertia and a mass having low moment of inertia at the initial start or a low-velocity section and Idle Go, and separating the mass having high moment of inertia from the flywheel unit in the high-velocity section.

Further, according to various aspects of the present invention, it is possible to prevent reduction of durability of the starter motor even in frequent restarting of the engine by ISG, by reducing the starting torque of the starter motor, using the accumulated rotational kinetic energy, by connecting again the mass having high moment of inertia in Idle Go that has been separated in Idle Stop by ISG.

In addition, according to various aspects of the present invention, it is not needed to increase the specification of a battery and an alternator which increases the cost of an ISG vehicle, and further improve fuel efficiency without increasing the weight, because the specification of the starter motor is not required to be increased in order to increase the durability even in the ISG vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view showing the configuration of an exemplary engine start apparatus of an Idle Stop and Go vehicle according to the present invention.

FIGS. 2A and 2B are graphs illustrating the implementation of an exemplary double-mass type flywheel in accordance with engine start conditions and engine load conditions, according to the present invention.

FIG. 3 is a graph illustrating the implementation of an exemplary double-mass type flywheel in accordance with vehicle mode conditions, according to the present invention.

FIG. 4 is a view showing the configuration of an engine restart apparatus of the related art.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

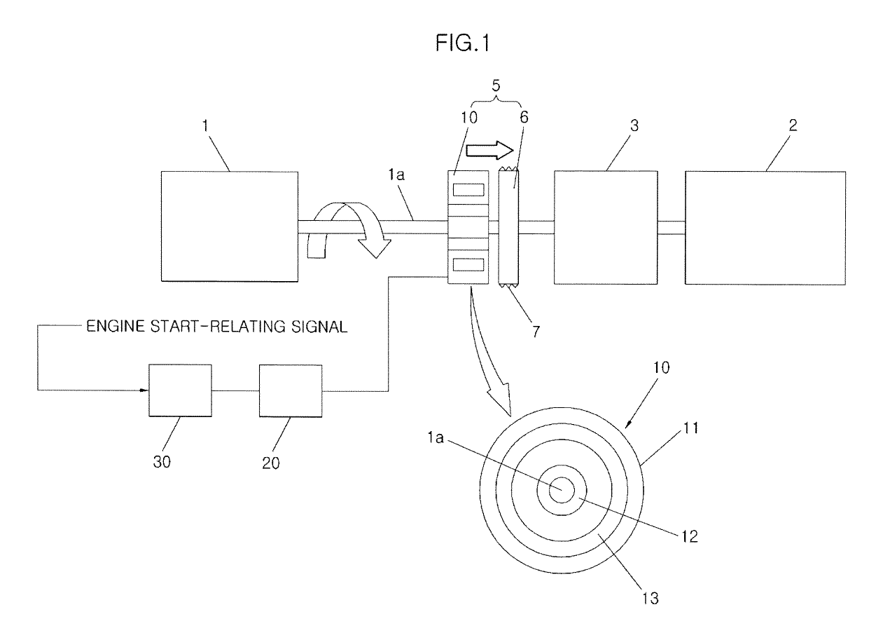

Referring to FIG. 1, an engine restart apparatus includes a double-mass type flywheel unit 5 disposed ahead of a power connector 3 that connects or disconnects power of an engine 1, between engine 1 and a power train 2, a power control circuit 20 connecting power of a battery to flywheel unit 5, and a controller 30 controlling power control circuit 20 such that current is supplied to flywheel unit 5 in accordance with the determined driving condition.

Power connector 3 is a manual clutch or a torque converter.

Double-mass type flywheel unit 5 includes a main flywheel 6 fixed to a crankshaft 1a of engine 1 and constantly rotating with engine 1 and a sub-flywheel 10 selectively connected with main flywheel 6 in accordance with conditions, such as whether the engine is started, the rotation section of the engine, and Idle Stop to Idle Go or vice versa by ISG.

The moment of inertia of main flywheel 6 is smaller than the moment of inertia of sub-flywheel 10 and the sum of the moment of inertia is the total moment of inertia of flywheel unit 5.

Therefore, when the same specification is applied, the magnitude of the total moment of inertia of flywheel unit 5 is the same as the magnitude of the total moment of inertia of an integral flywheel implemented by one moment of inertia mass.

Main flywheel 6 is implemented by a mass having low moment of inertia with a shaft hole at the center and fitted on crankshaft la of engine to simultaneously rotate, and has a ring gear 7 on the outer circumferential surface where a pinion gear of the starter motor is engaged.

Main flywheel 6 has a feature that is appropriate for high velocity because of the low moment of inertia.

On the contrary, sub-flywheel 10 is implemented by a mass having high moment of inertia, rotatably fitted on crankshaft 1a of engine to store wasted kinetic energy into rotational kinetic energy, and combined with main flywheel 6 by a magnetic force generated when electric current is supplied.

Sub-flywheel 10 has a feature that is appropriate for low velocity because of the high moment of inertia.

For this configuration, sub-flywheel 10 includes a flywheel mass 11 that is a mass having the moment of inertia with a shaft hole at the center, a ball bearing 12 that is combined with crankshaft 1a of engine 1 passing through the shaft hole and freely rotates flywheel mass 11, and an electromagnetic clutch 13 that generates a magnetic force when the electric current is applied.

Electromagnetic clutch 13 is a friction type and mounted coaxially with flywheel mass 11. One will appreciate that other types of clutches can be used.

Power control circuit 20 is composed of common electric elements switching the battery current and controller 30 is provided with a driving logic for double-mass type flywheel unit 5 in addition to a common engine control-relating logic.

Input for the driving logic includes an engine load condition, an engine start condition, and a vehicle mode condition. By considering these conditions, engine torque burden and starter motor torque burden may be reduced by combining or separating sub-flywheel 10 and main flywheel 6 in double-mass type flywheel unit 5.

The engine load condition, engine start condition, and vehicle mode condition can be applied in various ways. In various embodiments, low-velocity section and high-velocity section conditions to the specific number of revolution of the engine are applied to the engine load condition, initial start of the engine and conversion into Idle Go from Idle Stop by ISG are applied to the engine start condition, and a fuel cut condition or a regenerative braking condition is applied to the vehicle mode condition.

The fuel cut condition or the regenerative braking condition, which is the vehicle mode condition, is implemented one at a time.

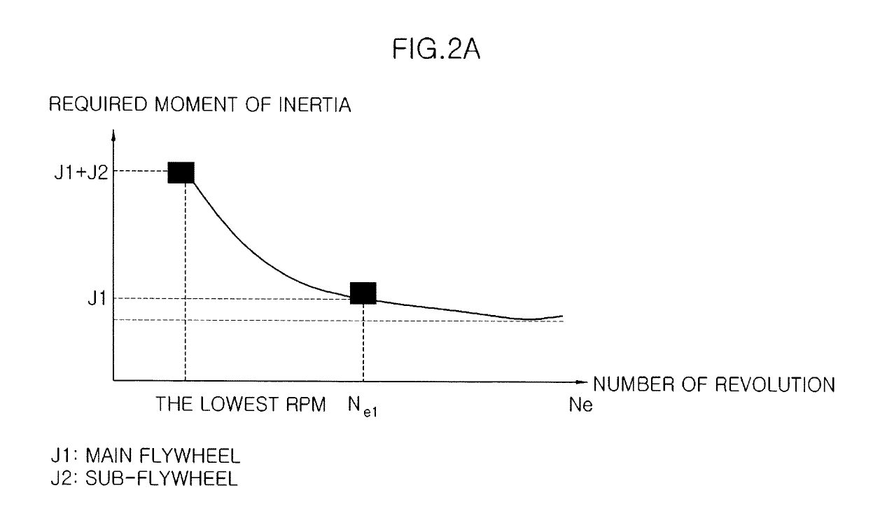

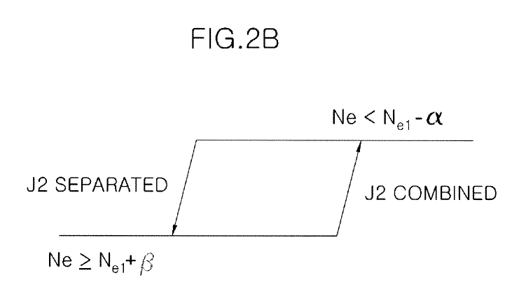

Referring to FIGS. 2A, the flywheel requires the larger moment of inertia J1+J2 at the lower number of revolution of the engine and requires relatively smaller moment of inertia J1 at the higher number of revolution of the engine.

For this feature, main flywheel 6 and sub-flywheel 10 are integrated and the engine torque consumption of flywheel unit 5 having the high moment of inertia J1+J2 is necessarily large. On the contrary, flywheel unit 5 having relatively low moment of inertia J1 by separation of main flywheel 6 from sub-flywheel 10 can reduce the engine torque consumption.

When the number of revolution of the engine for a specific condition Ne1 at which the high moment of inertia J1+J2 is converted into the relatively low moment of inertia J1 from this feature is defined, it is possible to determine the engine start condition and the engine load condition from the number of revolution of the engine for a specific condition Ne1.

The number of revolution of the engine for a specific condition Ne1 depends on the specification of flywheel unit 5. For example, the number of revolution of the engine for about 30 Kph may be used as the number of revolution of the engine for a specific condition Ne1.

As shown in FIG. 2B, the number of revolution of the engine for a specific condition Ne1 is used as a determination value for combining or separating main flywheel 6 and sub-flywheel 10.

The determination value is determination number of revolution of engine Ne<number of revolution of engine for specific condition Ne1−α or determination number of revolution of engine Ne≧number of revolution of engine for specific condition Ne1+β, where α and β are factors that are various values according to the traveling condition of the vehicle and the state of the engine.

For example, for determination number of revolution of engine Ne<number of revolution of engine for specific condition Ne1−α, flywheel unit 5 is integrated by combination of main flywheel 6 and sub-flywheel 10 and has the total moment of inertia J1+J2, which relatively increases the amount of engine torque consumption.

When flywheel unit 5 having large moment of inertia is required, as described above, it means the low-velocity section in the engine load condition or the initial start of engine or conversion into Idle Go from Idle Stop by ISG in the engine start condition.

In various embodiments, when controller 30 determines determination number of revolution of engine Ne<number of revolution of engine for specific condition Ne1−α, controller 30 switches power control circuit 20 such that the electric current is supplied to sub-flywheel 10.

Referring to FIG. 1 again, the electric current supplied to sub-flywheel 10 magnetizes an electromagnet clutch 13 and magnetized electromagnetic clutch 13 pulls adjacent main flywheel 6 by generating a magnetic force.

However, main flywheel 6 is fixed to crankshaft 1a of engine 1, while sub-flywheel 10 is combined through ball bearing 12, such that the magnetic force of sub-flywheel 10 acts as a force moving sub-flywheel 10 to main flywheel 6.

Accordingly, the moment of inertia J2 of sub-flywheel 10 is exerted in crankshaft 1a of engine 1, in addition to the moment of inertia J1 of main flywheel 6, which means that flywheel unit 5 is converted into the high moment of inertia J1+J2.

In this state, when the starter motor is operated, the high moment of inertia J1+J2 of flywheel unit 5 required for starting the engine is exerted in crankshaft 1a of engine 1, such that the engine can be smoothly started.

On the other hand, for determination number of revolution of engine Ne number of revolution of engine for specific condition Ne1+β, flywheel unit 5 is separated by separation of main flywheel 6 from sub-flywheel 10 and has only the relatively low moment of inertia J1 of main flywheel 6 in comparison to the total moment of inertia J1+J2, which correspondingly decreases the amount of engine torque consumption.

As described above, when flywheel unit 5 having the relatively low moment of inertia J1 is required, it means the high-velocity section in the engine load condition or the fuel cut condition or the regenerative braking condition in the vehicle mode condition.

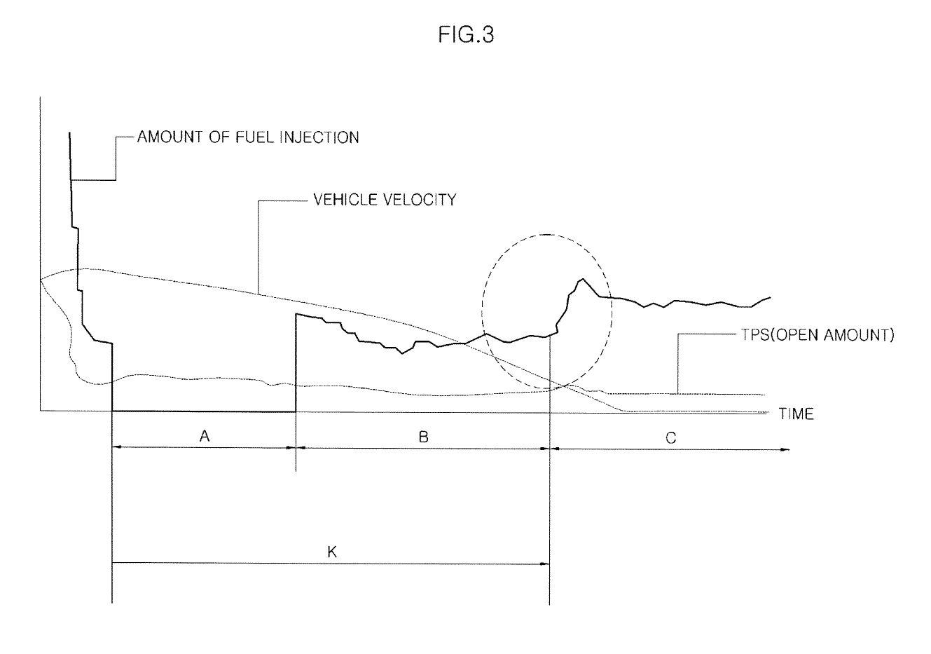

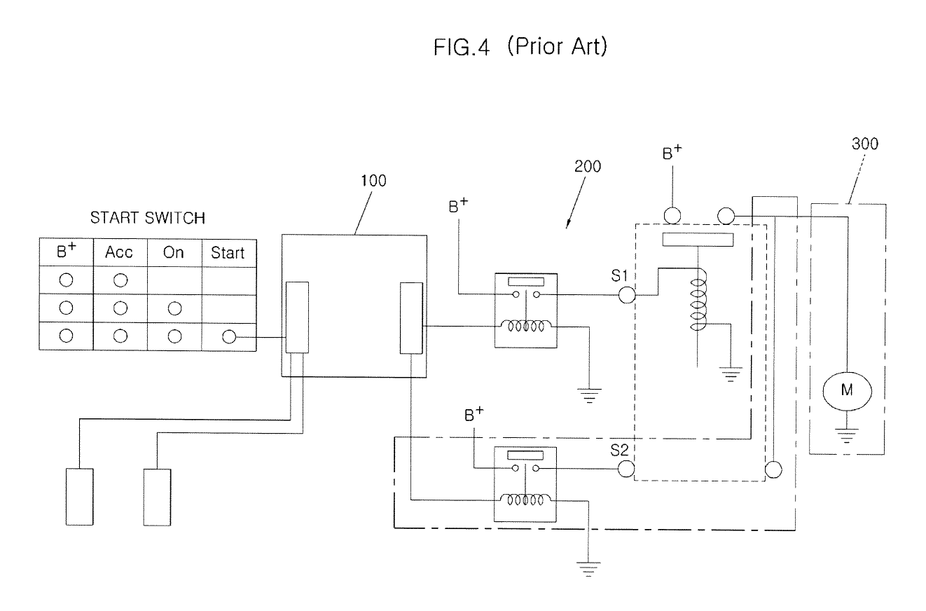

The high-velocity section is determined as the number of revolution of engine for a specific condition Ne1, as in FIG. 2, but the fuel cut condition or the regenerative braking condition is defined by FIG. 3.

Referring to FIG. 3, a general traveling section C connected with the regenerative braking section K according to the traveling state of the vehicle is shown together with a throttle open amount TPS, and the regenerative braking section K is generally defined as another traveling section over a vehicle velocity of 30 kph and divided into a fuel cut section A and a minimum fuel injection section B.

In various embodiments, when controller 30 determines determination number of revolution of engine Ne≧number of revolution of engine for specific condition Ne1+β, controller 30 switches power control circuit 20 again such that the electric current supplied to sub-flywheel 10 is cut.

Referring to FIG. 1 again, electromagnetic clutch 13 of sub-flywheel 10 is not magnetized any more by cutting the electric current and the magnetic force combining sub-flywheel 10 with main flywheel 6 is correspondingly removed, such that sub-flywheel 10 and main flywheel 6 are separated.

The separation is based on that main flywheel 6 is fixed to crankshaft 1a of engine 1 without moving, whereas sub-flywheel 10 is rotatably combined through ball bearing 12.

Flywheel unit 5 is converted into the low moment of inertia J1 from the high moment of inertia J1+J2, which means that crankshaft 1a of engine 1 receives only the moment of inertia from main flywheel 6.

Therefore, the flywheel unit 5 can considerably decrease the torque taken from the engine through crankshaft 1a, such that it is possible to reduce unnecessary engine torque consumption and improve fuel efficiency of the engine from the prevention of engine torque consumption.

Sub-flywheel 10 stores rotational kinetic energy by rotation and the stored rotational kinetic energy contributes to reducing the rotational inertia of main flywheel 6, such that the torque load of the starter motor can be reduced.

As described above, the engine restart apparatus according to various embodiments can improve fuel efficiency and reduce the torque of the engine by keeping the total of moment of inertia of flywheel unit 5 high in starting of engine or the low-velocity section and keeping it low in the high-velocity section. The present invention can prevent reduction of durability of the starter motor by reducing start torque of the starter motor, using the rotational kinetic energy accumulated in the mass having high moment of inertia in conversion into Idle Go from Idle Stop by ISG. This is achieved by using double-mass type flywheel unit 5 comprised of main flywheel 6 having the ring gear to rotate with an engine connected through the power train and receive power from the starter motor, and sub-flywheel 10 combined or separated from main flywheel 6.

For convenience in explanation and accurate definition in the appended claims, the terms larger or smaller, higher or lower, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. An engine restart apparatus comprising:
a main flywheel affixed to a crankshaft of an engine selectively connected to a power train, the main flywheel having a ring gear on an outer circumferential surface to receive a torque from a starter motor, and implemented with a mass having a moment of inertia of the main flywheel; and
a sub-flywheel rotatably fitted on the crankshaft of the engine and selectively connected to the main flywheel, the sub-flywheel implemented with a mass having a moment of inertia of the sub-flywheel, increasing a moment of inertia of a flywheel unit by being engaged and rotated with the main flywheel.

2. The apparatus as defined in claim 1, wherein the moment of inertia of the main flywheel is low for a high velocity, while the moment of inertia of the sub-flywheel is high for a low velocity.

3. The apparatus as defined in claim 2, wherein the sub-flywheel is moved to the main flywheel by a magnetic force generated by applying an electric current, and combined with the main flywheel.

4. The apparatus as defined in claim 1, wherein the main flywheel is fitted on the crankshaft of the engine through a shaft hole at a center of the main flywheel and simultaneously rotates with the engine; and
the sub-flywheel includes a flywheel mass rotatably fitted on the crankshaft of the engine through a ball bearing, and an electromagnetic clutch providing a magnetic pulling force generated by the applied electric current, wherein the ball bearing is fitted in a shaft hole at a center of the flywheel mass.

5. The apparatus as defined in claim 4, wherein the electromagnetic clutch is disposed inside the flywheel mass, substantially coaxially with the shaft hole, and forms an electric circuit to receive a current from the battery.

6. The apparatus as defined in claim 1, wherein driving conditions of the engine for determining whether to combine or separate the main flywheel and the sub-flywheel include an engine load condition, an engine start condition, and a vehicle mode condition,
wherein low-velocity section and high-velocity section conditions are applied to the engine load condition, an initial start of the engine and a conversion into Idle Go from Idle Stop by ISG are applied to the engine start condition, and a fuel cut condition or a regenerative braking condition is applied to the vehicle mode condition.

7. The apparatus as defined in claim 6, wherein a total moment of inertia of the sub-flywheel and the main flywheel acts as a load on the crankshaft of the engine when the engine load condition is the low-velocity section condition, and/or the engine start condition is the initial start of the engine or the conversion into Idle Go from Idle Stop by ISG, whereas only the moment of inertia of the main flywheel acts as the load on the crankshaft of the engine when the engine load condition is the high-velocity section condition, and/or the vehicle mode condition is the fuel cut condition or the regenerative braking condition.

8. The apparatus as defined in claim 6, wherein the low-velocity section condition is defined as Ne<Ne1−α and the high-velocity section condition is defined as Ne≧Ne1+β,
wherein Ne is a number of revolution of the engine, Ne1 is a number of revolution of the engine for a specific condition, and α and β are predetermined factors.

9. An engine restart apparatus comprising:
a double-mass type flywheel unit including a main flywheel rotating with an engine connected to a power train and having a ring gear to receive a power from a starter motor and a sub-flywheel rotatably fitted on a crankshaft of the engine and selectively connected to the main flywheel;
a power control circuit forming an electric circuit connecting a battery with the sub-flywheel; and
a controller for controlling the flywheel unit based on an engine load condition, an engine start condition and a vehicle mode condition,
wherein a low-velocity section condition and a high-velocity section condition are applied to the engine load condition, an initial start of the engine and a conversion into Idle Go from Idle Stop by ISG are applied to the engine start condition, and where a fuel cut condition or a regenerative braking condition is applied to the vehicle mode condition,
wherein the controller combines the sub-flywheel with the main flywheel by connecting an electric current supplied to the sub-flywheel through a power control circuit or separates the sub-flywheel from the main flywheel by cutting the electric current supplied to the sub-flywheel, in accordance with the engine load condition, the engine start condition, and the vehicle mode condition.

10. The apparatus as defined in claim 9, wherein the main flywheel has the ring gear on an outer circumferential surface and is fitted on the crankshaft of the engine to simultaneously rotate through a shaft hole at a center of the main flywheel, and
the sub-flywheel includes a flywheel mass rotatably fitted on the crankshaft of the engine through a ball bearing fitted in a shaft hole at a center of the flywheel mass, and an electromagnetic clutch providing a magnetic pulling force generated by the applied electric current.

11. The apparatus as defined in claim 9, wherein a total moment of inertia of the sub-flywheel and the main flywheel acts as a load on the crankshaft of the engine when the engine load condition is the low-velocity section condition, and/or the engine start condition is the initial start of the engine or the conversion into Idle Go from Idle Stop by ISG, whereas only the moment of inertia of the main flywheel acts as the load on the crankshaft of the engine when the engine load condition is the high-velocity section condition, and/or the vehicle mode condition is the fuel cut condition or the regenerative braking condition.

12. The apparatus as defined in claim 11, wherein the low-velocity section condition is defined as Ne<Ne1−α and the high-velocity section condition is defined as Ne≧Ne1+β,
wherein Ne is a number of revolution of the engine, Ne1 is a number of revolution of the engine for a specific condition, and α and β are predetermined factors.
